(19) United States
(12) Patent Application Publication
(10) Pub. No.: US 2024/0048393 A1
(43) Pub. Date: Feb. 8, 2024

(54) A LOW FOOTPRINT HARDWARE ARCHITECTURE FOR DILITHIUM DIGITAL SIGNATURE SCHEME

(71) Applicant: PQSecure Technologies, LLC, Boca Baton, FL (US)

(72) Inventor: Luke Beckwith, Boca Raton, FL (US)

(73) Assignee: PQSecure Technologies, LLC, Boca Raton, FL (US)

(21) Appl. No.: 17/641,950

(22) PCT Filed: Apr. 23, 2021
(86) PCT No.: PCT/US21/29009

§ 371 Date: Oct. 27, 2022

(51) Int. Cl. H04L 9/32

(52) U.S. Cl. CPC H04L 9/3247

(57) ABSTRACT

A low footprint hardware architecture for a Dilithium digital signature scheme that includes a plurality of submodules resident in a coprocessor that are operably configured to carry out a plurality of mathematical instructions employed in performing a plurality of cryptographic Dilithium algorithms at security levels 2, 3, and 5 of a final version of a NIST submission package.

### FIELD OF THE INVENTION

The present invention relates generally to hardware, systems, and methods directed toward lattice-based digital signature schemes, and, more particularly, relates to the Dilithium digital signature scheme which utilizes lattices as a method to generate cryptographic signatures using the module learning with errors problem.

### BACKGROUND OF THE INVENTION

Cryptology is the field of designing and implementing mathematical algorithms to provide services such as data confidentiality, integrity, and authentication. These cryptographic services allow parties to communicate securely even in with potential active or passive adversaries accessing the communication channel. A cryptosystem is a suite of algorithms which provide a set of these cryptographic services. A digital signature scheme is a type of cryptosystem which provides message integrity, authenticity, and non-repudiation. Said another way, generated signatures allow for authentication of the message author and confirm integrity of the message data. As opposed to other cryptosystems such a Key Encapsulation Mechanisms (KEM) which enable key exchanges, digital signatures allow parties to verify that a message is from the expected source and that the message data has not been modified or corrupted. They accomplish this by creating a cryptographic signature based on the private key and message which can then be verified by the receiving party using the message and public key. The services provided by signature schemes are necessary for many secure applications, including lightweight IoT devices which often need to secure the data they transmit. However, these IoT devices are also designed to use as little power and silicon resources as possible. Currently there is a lack of solutions for lattice-based digital signature schemes for these constrained devices. Existing implementations consume substantial amounts of energy and resources and thus are unsuitable for IoT devices.

Therefore, a need exists to overcome the problems with the prior art as discussed above.

### SUMMARY OF THE INVENTION

The invention provides a full hardware architecture for implementing the Dilithium Digital Signature scheme (DS) with minimal area. This system is composed with a plurality of modules necessary to perform the polynomial generation, arithmetic, poly encoding, and poly decoding required to generate the public key, private key, signature, and to verify signature correctness. The spirit of this invention is to provide an architecture with minimal resource consumption for the Dilithium lattice-based DS.

This system provides an entire architecture for performing the Dilithium operations of key generation, signature generation, and signature verification at the security levels of (2,3,5) as described in the Dilithium 3.1 specification. The hardware architecture may include the following primary modules (which includes submodules): A poly decoder module, a poly encoder module, a sampler module, a “sampleInBall” module, an arithmetic unit or module, a check norm unit or module, an address generator for the Number Theoretic Transform (NTT), a ROM module to store the NTT twiddle factors, a hint generation module, a SHA3 coprocessor, a data RAM module, a polynomial RAM module, and a First In First Out (FIFO) interface for transfer data to and from the module(s).

Said modules were designed in such a manner as to minimize the resources required to implement in hardware. This includes reuse of multiplier and modular arithmetic units, reuse of poly encoding and poly decoding resources, reuse of resources used for uniform sampling of polynomial coefficients, as well as sequential performance of operation to minimize memory requirements.

A single module is used to perform all arithmetic operations required for completion of the Dilithium algorithms including: Cooley-Tukey butterfly, Gentlemen-Sande butterfly, modular multiplication, modular addition, modular subtraction, decomposition, and modular multiply accumulate. For rejection conditions in the signing and verification process, the max norm is checked during operation within the previously described module.

A single module is used for sampling all polynomial matrices and vectors at all security levels. A single module is used for encoding polynomials at all encoding levels used in Dilithium. A single module is also used for decoding polynomials at all encoding levels.

In accordance with one embodiment of the present invention, a low footprint hardware architecture for a Dilithium digital signature scheme that includes a plurality of submodules resident in a coprocessor that are operably configured to carry out a plurality of mathematical instructions employed in performing a plurality of cryptographic Dilithium algorithms at security levels 2, 3, and 5 of a final version of a NIST submission package.

In another embodiment of the present invention, the plurality of cryptographic Dilithium algorithms are operably configured to be performed by the submodules in a sequential manner.

In additional embodiments of the present invention, a sole arithmetic module is utilized and is operably configured to perform all arithmetic operations within the plurality of cryptographic Dilithium algorithms.

In a further embodiment of the present invention, the arithmetic operations are selected from at least one of the group of: Cooley-Tukey butterfly, Gentlemen-Sande butterfly, modular multiplication, modular addition, modular subtraction, decomposition and modular multiply accumulate. Furthermore, the arithmetic operations may include the entire group of Cooley-Tukey butterfly, Gentlemen-Sande butterfly, modular multiplication, modular addition, modular subtraction, decomposition and modular multiply accumulate.

In another embodiment of the present invention, the sole arithmetic module is operably configured to utilize a singular modular multiplier, a singular modular adder, and a singular modular subtractor.

In an additional embodiment of the present invention, the singular modular multiplier is operably configured to perform decomposition at the security levels 2, 3, and 5 of the final version of the NIST submission package.

In a further embodiment of the present invention, one of the plurality of submodules includes a sampler submodule operably configured to perform sampling for a plurality of matrices and a plurality of vectors employed in the performance of the plurality of cryptographic Dilithium algorithms. Additionally, the sampler submodule is singular or sole sampler submodule utilized in the architecture.

In another embodiment of the present invention, two of the plurality of submodules include a polynomial decoder submodule operably configured to decode from an array of bytes to an array of polynomial coefficients employed in the performance of the plurality of cryptographic Dilithium algorithms and a polynomial encoder submodule operably configured to encode from the array of polynomial coefficients to the array of bytes to employed in the performance of the plurality of cryptographic Dilithium algorithms.

The present invention may also include a low footprint hardware architecture for a Dilithium digital signature scheme having a plurality of submodules resident in a coprocessor that are operably configured to carry out a plurality of mathematical instructions in a sequential manner employed in performing a plurality of cryptographic Dilithium algorithms. The plurality of submodules may include a sole arithmetic module operably configured to perform all arithmetic operations within the plurality of cryptographic Dilithium algorithms and a sole sampler submodule operably configured to perform sampling for a plurality of matrices and a plurality of vectors employed in the performance of the plurality of cryptographic Dilithium algorithms.

In additional embodiments of the present invention, the plurality of cryptographic Dilithium algorithms occur at security levels 2, 3, and 5 of a final version of a NIST submission package.

### BRIEF DESCRIPTION OF THE DRAWINGS

FIG. 1 is a diagram showing the interconnection of signature scheme algorithms in accordance with one embodiment of the present invention;

FIG. 2 is a process flow diagram depicting a schedule of mathematical instructions for key generations in accordance with one embodiment of the present invention;

FIG. 3 is a process flow diagram depicting a schedule of mathematical instructions for signature generations in accordance with one embodiment of the present invention;

FIG. 4 is a process flow diagram depicting a schedule of mathematical instructions for signature verifications in accordance with one embodiment of the present invention;

FIG. 5 is a process flow diagram depicting the schedule of mathematical instruction for matrix multiplications in accordance with one embodiment of the present invention;

FIG. 6 is a schematic block diagram depicting a general form of a lattice-based architecture for digital signatures and a plurality of submodules in accordance with one embodiment of the present invention;

FIG. 7 is a schematic block diagram depicting an internal layout of a modular multiplier which performs modular multiplication using Barrett reduction as well as decomposition as required by Dilithium in accordance with one embodiment of the present invention;

FIG. 8 is a schematic block diagram depicting an internal layout of a module used for uniform sampling of all variables required in Dilithium in accordance with one embodiment of the present invention;

FIG. 9 reports the performance and area result for the architecture as synthesized for ASIC implementations in accordance with one embodiment of the present invention;

FIG. 10 is a schematic block diagram depicting an internal layout of a module used for performing all of the arithmetic operations required in the Dilithium algorithms;

FIG. 11 is a schematic block diagram depicting an internal layout of a module used for encoding polynomial coefficients to a stream of bytes; and

FIG. 12 is a schematic block diagram depicting an internal layout of a module used for decoding a stream of bytes into a stream of polynomial coefficients.

### DETAILED DESCRIPTION

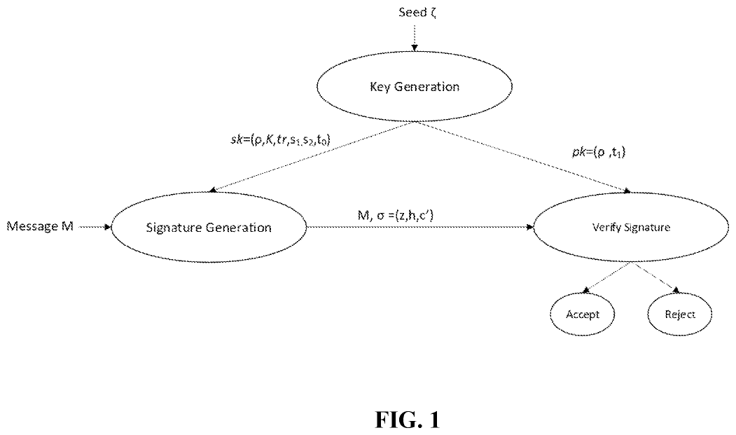

The present invention provides a novel and area efficient hardware architecture for implementing the Dilithium lattice-based DS. The invention provides modules and a combination of operations using those modules to implement the functions of key generation, signature generation, and signature verification as security levels 2, 3, and 5. FIG. 1. shows how these functions are used in communication between two parties.

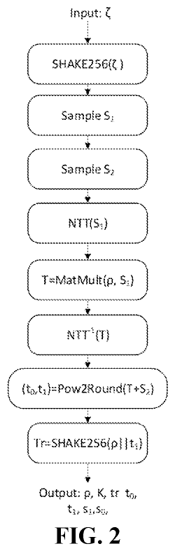

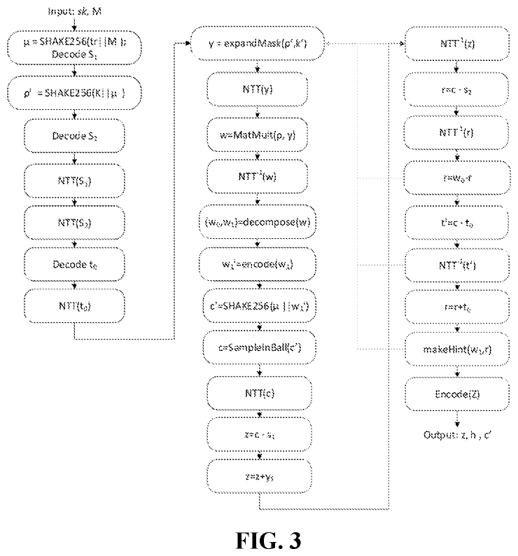

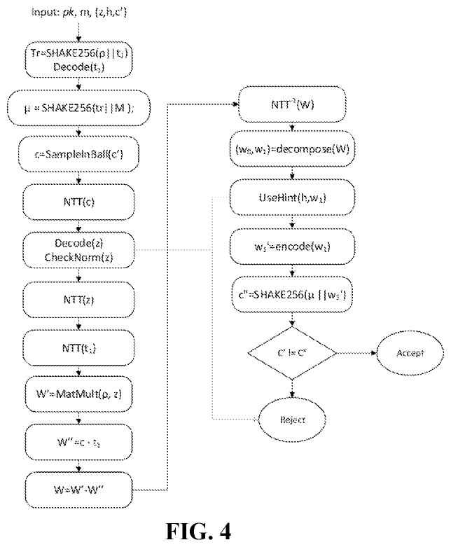

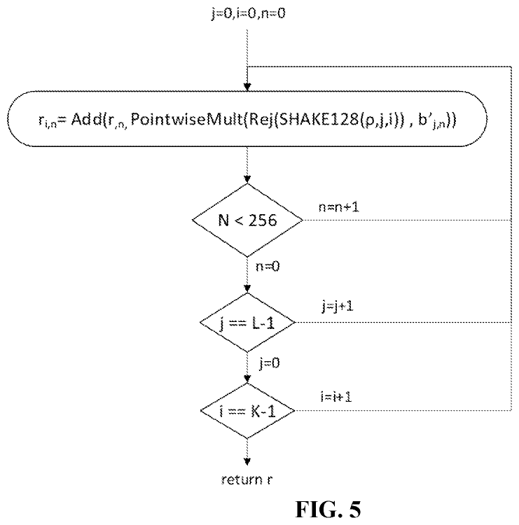

With reference first to FIG. 2, said figure shows the schedule of instructions for performing key generation. FIG. 3. shows the schedule of instructions for performing signature generation. FIG. 4. show the schedule of instructions for performing signature verification. FIG. 5. shows the subfunction for matrix multiplication which performs the matrix multiplication operations in a sequential manner with coefficient sampled directly from the pseudorandom stream to minimize the area and memory required by the operation. As shown in FIGS. 2-5, the operation schedule is designed to be linear as to minimize the number of memory interfaces required for the design. Said another way, FIGS. 2-5 depict a plurality of mathematical instructions employed in performing a plurality of cryptographic Dilithium algorithms at security levels 2, 3, and 5 of a final version of a NIST submission package in order to authenticate using a low footprint hardware. The final version of the NIST submission package is known and accessible to those of skill in the art.

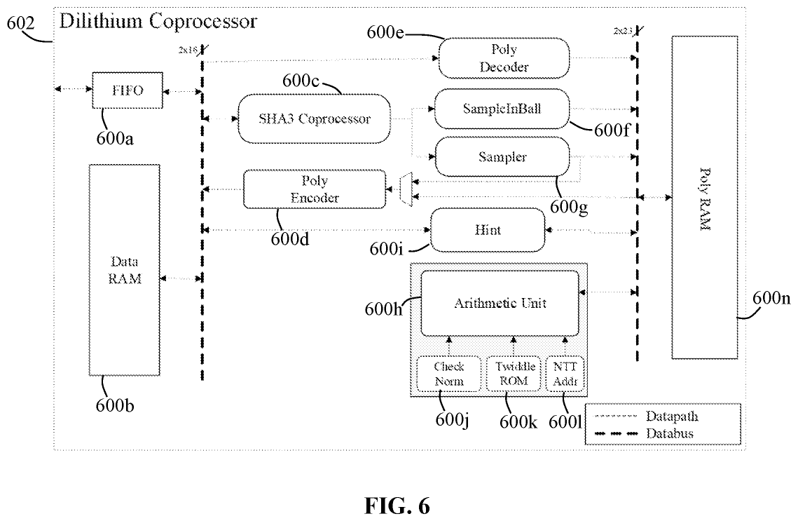

One embodiment of present invention, which can be described as an implemented accelerator or coprocessor implementing said operations of FIGS. 2-5 is depicted in FIG. 6. The hardware depicted in FIG. 6. is implemented efficiently and beneficially for lattice-based operations used in Dilithium to reduce silicon area footprint. In one embodiment, the accelerator or coprocessor includes 13 submodules. Said differently, a plurality of submodules 600a-n (as exemplified in FIG. 6, wherein “n” is any number greater than one) are resident (instantiated) in a coprocessor 602 that are operably configured to carry out a plurality of mathematical instructions employed in performing a plurality of cryptographic Dilithium algorithms at security levels 2, 3, and 5 of the final version of the NIST submission package.

The submodules 600a-n are configured to implement the Dilithium algorithms of key generation, signature generation, and signature verification at all security levels. Each module may be instantiated only one time to minimize footprint of the design or architecture. A SHA3-Coprocessor 600c, for example, may be a publicly available open-source coprocessor implementation and is used for all hashing and pseudorandom data generation. The norm check modules 600j is integrated with the arithmetic unit 600h to allow verification of the rejection condition during the completion of polynomial arithmetic. The one or more subcontrol module(s) may also manage the submodules.

In one embodiment, the plurality of cryptographic Dilithium algorithms are operably configured to be performed by the submodules in a sequential manner (e.g., depicted in FIGS. 2-5). As discussed herein, one of the modules 600a-n include the sampler submodule 600g, which may or may not be a singular sampler module utilizes the inventive architecture. Additionally, the sampler submodule 600g may be operably configured to perform sampling for a plurality of matrices and a plurality of vectors employed in the performance of the plurality of cryptographic Dilithium algorithms. Furthermore, two of the plurality of submodules 600a-n include a polynomial decoder submodule 600f operably configured to decode from an array of bytes to an array of polynomial coefficients employed in the performance of the plurality of cryptographic Dilithium algorithms and a polynomial encoder submodule 600d operably configured to encode from the array of polynomial coefficients to the array of bytes to employed in the performance of the plurality of cryptographic Dilithium algorithms.

One of the modules includes the arithmetic unit 600h, which may be the sole or unitary arithmetic module utilized in the architecture, wherein the arithmetic unit 600h is operably configured to perform all arithmetic operations within the plurality of cryptographic Dilithium algorithms. Furthermore, the arithmetic operations may include one, more than one, or all of the following: Cooley-Tukey butterfly, Gentlemen-Sande butterfly, modular multiplication, modular addition, modular subtraction, decomposition and modular multiply accumulate. Furthermore, the arithmetic module 600h may be also operably configured to utilize a singular modular multiplier, a singular modular adder, and a singular modular subtractor.

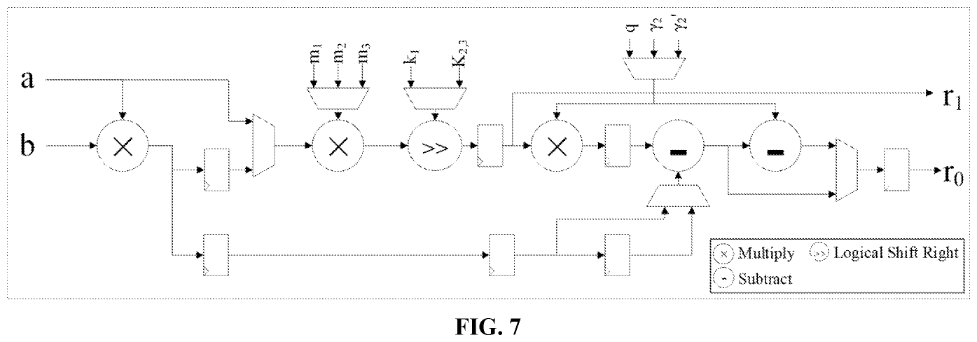

With reference to FIG. 7, one embodiment of the present invention includes a modular multiplier configured to perform Barrett reduction as well as decomposition for all security levels 2, 3, and 5. Decomposition calculates r₁, r₂ such that r=r₁*α+r₂ for the α values specified in Dilithium DS. These operations are performed with reuse of multipliers, right shifters, and subtractors. The module is configured such that m₁=8396807, m₂=11545611, m₃=4198404, k₁=46, k_{2,3}=41, q=8380417, g₂=190464, g_{2′}=523776, allowing the module to complete reduction and decomposition at all levels required in Dilithium DS. FIG. 7 depicts a unique internal layout of the modular multiplier that includes, as depicted and exemplified in the figures, various specially configured electronic switches, shifts, etc., that enables performance of Barrett reduction as well as decomposition for all security levels 2, 3, and 5. Said another way, the modular multiplier is operably configured to perform decomposition at the security levels 2, 3, and 5 of the final version of the NIST submission package.

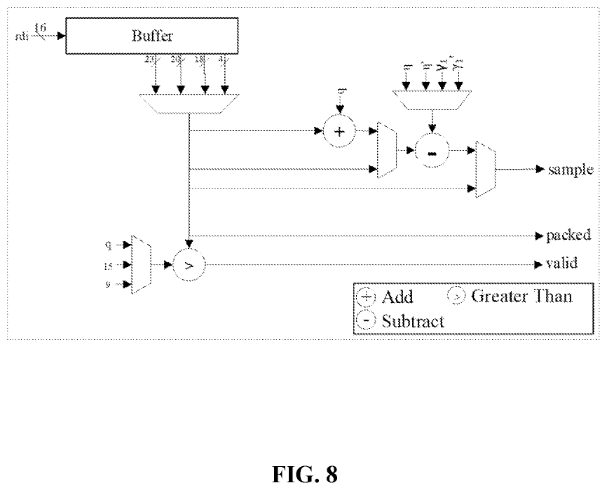

With reference to FIG. 8, an exemplary sampler 600g configured to sample all vectors and matrices described in Dilithium is depicted. Said another way, FIG. 8 depicts an exemplary internal layout of a module utilized for uniform sampling. This includes rejecting invalid samples as well as centering samples around 0 when required as described in the Dilithium 3.1 specification. This is accomplished using an input buffer which accepts values at the bus width and converts it to the various widths required for Dilithium samples combined with a condition operator to accept or reject samples and a conditional module subtractor to center values around 0 as specified for the Dilithium algorithm.

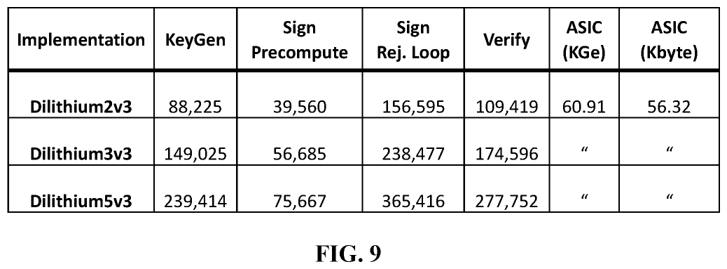

FIG. 9 depicts an exemplary chart reports our performance and area results as synthesized for ASIC. Multipliers are synthesized using LUTs. The design consumes the least resources of any design to date in terms of LUTs, FFs, and BRAM for a single module capable of performing all Dilithium algorithms at all NIST recommended security levels.

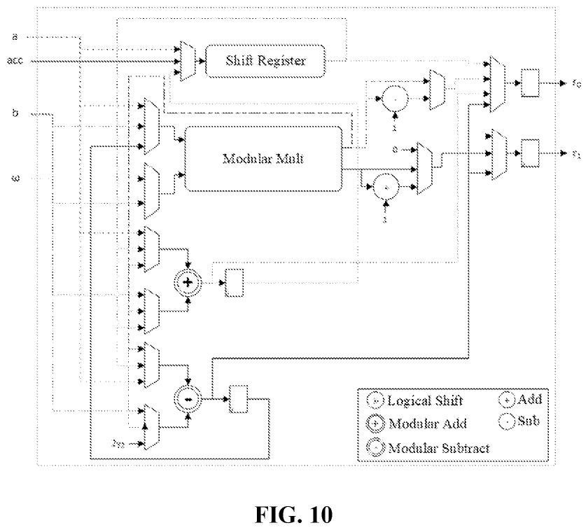

With reference to FIG. 10, an exemplary arithmetic unit 600h configured to perform all arithmetic operations used in Dilithium is depicted. Said another way, FIG. 10 depicts an exemplary internal layout of a module utilized to perform the required arithmetic operations including Cooley-Tukey butterfly, Gentlemen-Sande butterfly, modular multiplication, modular addition, modular subtraction, decomposition and modular multiply accumulate.

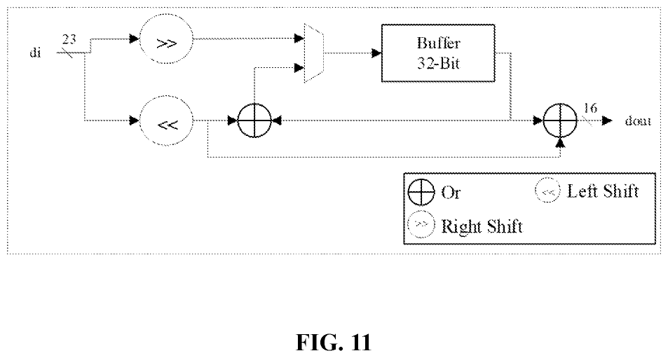

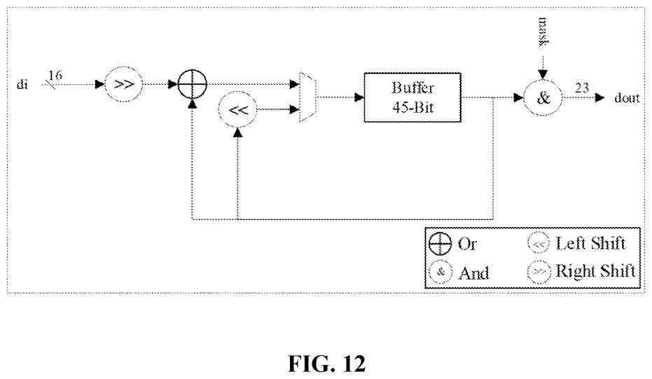

With reference to FIG. 11, an exemplary poly encoder 600d configured to encode polynomial coefficients for elements used in Dilithium is depicted. Said another way, FIG. 11 depicts an exemplary internal layout of a module utilized for encoding of polynomials coefficients at all bit-levels required in performing the Dilithium algorithms. With reference to FIG. 12, an exemplary poly decoder 600e configured to decode polynomial coefficients from a byte stream for elements used in Dilithium is depicted. Said another way, FIG. 12 depicts an exemplary internal layout of a module utilized for decoding of polynomials coefficients at all bit-levels required in performing the Dilithium algorithms.

What is claimed is:

1. A low footprint hardware architecture for a Dilithium digital signature scheme comprising:
a plurality of submodules resident in a coprocessor that are operably configured to carry out a plurality of mathematical instructions employed in performing a plurality of cryptographic Dilithium algorithms at security levels 2, 3, and 5 of a final version of a NIST submission package, wherein the plurality of submodules includes a sole arithmetic module operably configured to perform all arithmetic operations within the plurality of cryptographic Dilithium algorithms, the sole arithmetic module having a modular multiplier:
including multipliers, right shifters, and subtractors; and
operably configured to perform decomposition at security levels 2, 3, and 5 of the final version of the NIST submission package using multipliers, right shifters, and subtractors shared with the modular multiplier.

2. The low footprint hardware architecture for the Dilithium digital signature scheme according to claim 1, wherein:
the plurality of cryptographic Dilithium algorithms are operably configured to be performed by the submodules in a sequential manner.

3. The low footprint hardware architecture for the Dilithium digital signature scheme according to claim 1, wherein the arithmetic operations further comprise at least one of the group of:
Cooley-Tukey butterfly, Gentlemen-Sande butterfly, modular multiplication, modular addition, modular subtraction, decomposition and modular multiply accumulate.

4. The low footprint hardware architecture for the Dilithium digital signature scheme according to claim 1, wherein the arithmetic operations further comprise the group of Cooley-Tukey butterfly, Gentlemen-Sande butterfly, modular multiplication, modular addition, modular subtraction, decomposition and modular multiply accumulate.

5. The low footprint hardware architecture for the Dilithium digital signature scheme according to claim 4, wherein:
the sole arithmetic module is operably configured to utilize a singular modular multiplier, a singular modular adder, and a singular modular subtractor.

6. The low footprint hardware architecture for the Dilithium digital signature scheme according to claim 1, wherein one of the plurality of submodules further comprises:
a sampler submodule operably configured to perform sampling for a plurality of matrices and a plurality of vectors employed in the performance of the plurality of cryptographic Dilithium algorithms.

7. The low footprint hardware architecture for the Dilithium digital signature scheme according to claim 1, wherein the sampler submodule is singular.

8. The low footprint hardware architecture for the Dilithium digital signature scheme according to claim 1, wherein two of the plurality of submodules further comprise:
a polynomial decoder submodule operably configured to decode from an array of bytes to an array of polynomial coefficients employed in the performance of the plurality of cryptographic Dilithium algorithms; and
a polynomial encoder submodule operably configured to encode from the array of polynomial coefficients to the array of bytes to employed in the performance of the plurality of cryptographic Dilithium algorithms.

9. A low footprint hardware architecture for a Dilithium digital signature scheme comprising:
a plurality of submodules resident in a coprocessor that are operably configured to carry out a plurality of mathematical instructions in a sequential manner employed in performing a plurality of cryptographic Dilithium algorithms, the plurality of submodules include:
a sole arithmetic module operably configured to perform all arithmetic operations within the plurality of cryptographic Dilithium algorithms; and
a sole sampler submodule operably configured to perform sampling for a plurality of matrices and a plurality of vectors employed in the performance of the plurality of cryptographic Dilithium algorithms.

10. The low footprint hardware architecture for the Dilithium digital signature scheme according to claim 9, wherein:
the plurality of cryptographic Dilithium algorithms occur at security levels 2, 3, and 5 of a final version of a NIST submission package.

11. The low footprint hardware architecture for the Dilithium digital signature scheme according to claim 9, wherein the arithmetic operations further comprise at least one of the group of:
Cooley-Tukey butterfly, Gentlemen-Sande butterfly, modular multiplication, modular addition, modular subtraction, decomposition and modular multiply accumulate.

12. The low footprint hardware architecture for the Dilithium digital signature scheme according to claim 11, wherein the arithmetic operations further comprise the group of Cooley-Tukey butterfly, Gentlemen-Sande butterfly, modular multiplication, modular addition, modular subtraction, decomposition and modular multiply accumulate.

13. The low footprint hardware architecture for the Dilithium digital signature scheme according to claim 11, wherein:
the sole arithmetic module is operably configured to utilize a singular modular multiplier, a singular modular adder, and a singular modular subtractor.

14. The low footprint hardware architecture for the Dilithium digital signature scheme according to claim 9, wherein two of the plurality of submodules further comprise:
a polynomial decoder submodule operably configured to decode from an array of bytes to an array of polynomial coefficients employed in the performance of the plurality of cryptographic Dilithium algorithms; and
a polynomial encoder submodule operably configured to encode from the array of polynomial coefficients to the array of bytes to employed in the performance of the plurality of cryptographic Dilithium algorithms.

15. The low footprint hardware architecture for the Dilithium digital signature scheme according to claim 13, wherein:
the sole arithmetic module is operably configured to utilize a singular modular multiplier, a singular modular adder, and a singular modular subtractor.

16. The low footprint hardware architecture for the Dilithium digital signature scheme according to claim 11, wherein two of the plurality of submodules further comprise:
a polynomial decoder submodule operably configured to decode from an array of bytes to an array of polynomial coefficients employed in the performance of the plurality of cryptographic Dilithium algorithms; and
a polynomial encoder submodule operably configured to encode from the array of polynomial coefficients to the array of bytes to employed in the performance of the plurality of cryptographic Dilithium algorithms.
